(19) United States
(12) Patent Application Publication
(10) Pub. No.: US 2009/0294289 A1
(43) Pub. Date: Dec. 3, 2009

(54) Hybrid System For Selective Removal Of Contaminants

(76) Inventors: Jeffery J. Haslam, Livermore, CA (US); William L. Bourcier, Livermore, CA (US); Kevin C. O'Brien, San Ramon, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(21) Appl. No.: 12/130,029

(22) Filed: May 30, 2008

(51) Int. Cl. C02F 1/469

(52) U.S. Cl. 204/524; 204/634

(57) ABSTRACT

A system for removing contaminants from water utilizes a layered stack of anion permeable membranes and cation permeable membranes positioned between an anode and a cathode. The layered stack of membranes forms a concentrate water stream flow channel and a diluent water stream flow channel. Ion specific ion exchange resins are inserted within the diluent water stream flow channel. The water stream is pumped through the layered stack of anion permeable membranes. By using the anode, the cathode, and the voltage source to place an electrical potential gradient across the layered stack of membranes the negative ions are drawn toward the anode and the positive ions are drawn toward the cathode in the diluent water stream that flows through the diluent water stream flow channel.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to removal of contaminates from fluid and more particularly to a hybrid approach for selective removal of contaminants from fluid.

2. State of Technology

State of Technology Information:

International Patent No. WO/03074430 by Vattenfall AB for nitrate removal provides the following state of technology information: “During recent decades, nitrate contamination in raw water sources have been increasing due to the intensive use of nitrogenous fertilizers, changes in land-use patterns (from pasture to arable), and the contamination of sewage and industrial effluents. It has been found that 15 nitrate levels have been increasing in drinking water supplies in the European Economic Community, the United States, Canada, Africa, the Middle East, Australia, and New Zealand (Kappor and Viraraghavan, 1997). Because an increased nitrate uptake can link to 20 several health hazards causing methaemolobinaemia or cancer risks due to nitrosamines or nitrosamides, limits have been set up to regulate the maximum nitrate levels in drinking water. In Europe, an EEC Directive on the quality of drinking water for human consumption specifies 25 a maximum admissible concentration of 50 mg NO3-/l, but a guide level of 25 mg NO3/l is recommended (European Community, 1980). The U.S. EPA establishes a maximum contaminant level (MCL) of 10 mg NO3—N/l corresponding to 44 mg NO3-/l (Pontius, 1993). The Health and Welfare 30 Canada has established a maximum acceptable concentration (MAC) of 10 mg NO3—N/l and the nitrite of 3.2 mg/l when nitrates and nitrites are measured separately in drinking water (Health and Welfare Canada, 1993).”

United States Published Patent Application No. 2005/0252857 by William Wilson et al for smart membranes for nitrate removal, water purification, and selective ion transportation provides the following state of technology information: “Dielectrophoresis is increasingly being employed to manipulate and separate molecules and particles including biological cells. Recent developments in nanotechnology enable structures to be built which can create fields and field gradients on unprecedented length scales; the scale of the variations in the field inducing charge on a molecule may be the same as the scale of the molecule itself. Synthetic nanopores have been fabricated in inorganic materials for transporting DNA. Carbon nanotubes have been aligned in a polymer film to demonstrate molecular transport through their cores. Dielectrophoresis has recently been employed to assemble nanowires in suspensions. Multilayer technology enables materials comprised of virtually any elements to be constructed with control on atomic dimensions.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a system for removing contaminants from water. The water includes a concentrate water stream and a diluent water stream. The system includes providing a layered stack of anion permeable membranes and cation permeable membranes, an anode, a cathode, and a voltage source connected to the anode and the cathode; positioning the layered stack of anion permeable membranes and cation permeable membranes between the anode and the cathode so that the layered stack of membranes forms a concentrate water stream flow channel between the alternating individual anion permeable membranes and individual cation permeable membranes and a diluent water stream flow channel between alternating individual anion permeable membranes and individual cation permeable membranes; inserting ion specific ion exchange resins within the diluent water stream flow channel; pumping the water stream through the layered stack of anion permeable membranes and cation permeable membranes, wherein the concentrate water stream flows through the concentrate water stream flow channel and wherein the diluent water stream flows through the diluent water stream flow channel and the ion specific ion exchange resins; using the anode, the cathode, and the voltage source to place an electrical potential gradient across the layered stack of anion permeable membranes and cation permeable membranes to produce negative ions and positive ions in the diluent water stream wherein the negative ions are drawn toward the anode and the positive ions are drawn toward the cathode in the diluent water stream that flows through the diluent water stream flow channel.

In one embodiment the present invention provides an apparatus including an anode; a cathode; a voltage source connected to the anode and to the cathode; a layered stack of membranes between the anode and the cathode, the layered stack of membranes having a multiplicity of anion permeable membranes positioned between the anode and the cathode, the multiplicity of anion permeable membranes including individual anion permeable membranes; a multiplicity of cation permeable membranes positioned between the anode and the cathode, the multiplicity of cation permeable membranes including individual cation permeable membranes, wherein the layered stack of membranes comprises alternating individual anion permeable membranes and individual cation permeable membranes; a concentrate water stream flow channel between the alternating individual anion permeable membranes and individual cation permeable membranes, a diluent water stream flow channel between alternating individual anion permeable membranes and individual cation permeable membranes; and ion specific ion exchange resins within the diluent water stream flow channel.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1A illustrates one embodiment of a system constructed in accordance with the present invention.

FIG. 1B show a portion of the system illustrated in FIG. 1A.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

Trace contaminants of ionic species/compounds or some dissolved molecular compounds are particular problems in some water sources. Perchlorate, arsenic, and nitrate are some examples of ionic contaminants which have either halted the use of some water sources or caused significantly increased costs to treat the water to meet current or likely future decreases in the allowable contaminant levels in drinking water. Similarly, these other ions may impact industrial, agricultural, or other water supply. Sometimes extensive removal of all ionic species in the water is required to meet the required level of removal for some of the trace contaminants which results in extensive costs (e.g. reverse osmosis and traditional electrodialysis). It is reasonable to consider significantly reducing treatment costs by just removing the contaminant specie/ion of interest. In particular, selective ion exchange has been attempted for perchlorate by Calgon, Inc. and US Filter, Inc.

These approaches still result in considerable volume of waste stream from regeneration of the ion exchange resins or in substantial quantities of ion exchange resin filled with the contaminant species/ions. Additionally, ion exchange is nominally a batch operation requiring either periodic regeneration of the ion exchange resin or periodic replacement and disposal of the exhausted resin.

The present invention seeks to use the selectivity of some ion exchange resins for target species such as perchlorate, arsenic, nitrate, or others combined with regeneration of the resins by electrodialysis to produce a concentrated waste stream. The present invention would allow for in place regeneration of the ion exchange resin as needed while concurrently continuing to remove the contaminants from the process stream.

Specifically, the process would be continuous without a requirement for either replacement of the ion exchange resin or taking the ion exchange resin bed out of service to allow for regeneration. It is believed that it will be possible to reduce the electrical regeneration costs below the cost associated with chemical regeneration while still maintaining the treatment process continuously. One element of the cost reduction maybe the elimination of cost due to chemical feed stocks and the labor associated with delivery, inspections, etc.

Since the process does not require chemical feedstocks, it can be more practically used in remote locations for longer periods. In particular, in many treatment operations, labor costs associated with maintenance and changing out the ion exchange resin are the primary cost of operation. It is further anticipated that the electrical regeneration will only be required periodically (particularly for trace contaminants) so that considerable cost savings may be obtained by reducing the amount of electrical power required compared to continuous electrodialysis. It is also anticipated that improved separation efficiency may be obtained by intentionally modifying the amount of a type of ion exchange resin so that only ions of a certain type are removed by the ion exchange resin. This may include preferentially including only an anion exchange resin within the process (or diluent) water stream. Alternatively, the ion exchange resin might include only cation resins for removal of specific cations. Also, some ratio of specific anion resins might be used to capture two co-contaminant species (e.g. perchlorate and nitrate present in the same water). The ratios may be set by the amount of contaminant present and the desired extent of removal. Also a mixture of selected or preferred ration of ion specific anion+cation resins may be used.

Present invention goes beyond ion exchange to remove perchlorate or other selected ions and goes beyond basic electrodialysis (ED) and typical forms of electrode-ionization (EDI) through the use of a single type of anion resin for removal/separation of a specific ion(s) of interest (or conversely a single type of cation resin for cation of interest or a specific chosen mixture). Alternatively, various mixtures of ion specific ionic exchange resins may be used.

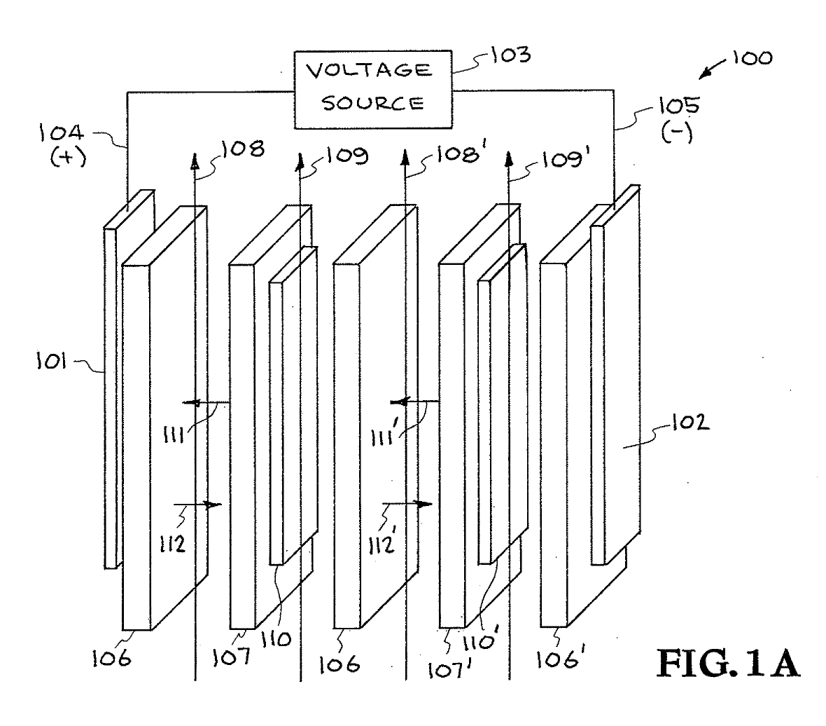

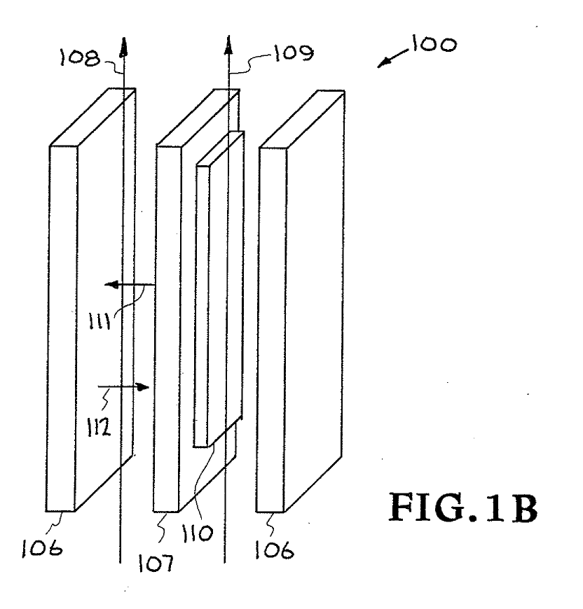

Referring now to the drawings and in particular to FIGS. 1A and 1B, one embodiment of a system constructed in accordance with the present invention is illustrated. The system is designated generally by the reference numeral 100. The system 100 utilizes “electrodialysis.” Electrodialysis is an electromembrane process in which ions are transported through ion permeable membranes from one solution to another under the influence of a potential gradient. In the prior art the membranes were copolymer membranes. The system 100 may use energy-efficient membranes including nonoporous membranes to replace the solid polymer membranes used in the prior art.

The electrical charges on the ions allow them to be driven through the membranes. Applying a voltage between two end electrodes generates the potential field required for this. Since the membranes used in electrodialysis have the ability to selectively transportions having positive or negative charge and reject ions of the opposite charge, useful concentration, removal, or separation of electrolytes can be achieved by electrodialysis.

In electrodialysis, transport of either positively charged ions (cations) or negatively charged ions (anions) through copolymer membranes is driven by a voltage applied by a pair of flat electrodes. The ions are driven toward the electrode with the opposite charge. Water flows between alternate cation-permeable and anion-permeable copolymer membrane sheets sandwiched between the electrodes and separated by spacers. As water flows between the membranes, salt is removed from one compartment and concentrated in adjacent compartments, with up to a hundred or more membrane pairs per stack. A manifold separates the exiting fluid into a relatively salt-free diluent product and a salt-enriched brine for disposal.

In electrodialysis, transport of either positively charged ions (cations) or negatively charged ions (anions) through copolymer membranes is driven by a voltage applied by a pair of flat electrodes. The ions are driven toward the electrode with the opposite charge. Water flows between alternate cation-permeable and anion-permeable copolymer membrane sheets sandwiched between the electrodes and separated by spacers. As water flows between the membranes, salt is removed from one compartment and concentrated in adjacent compartments, with up to a hundred or more membrane pairs per stack. A manifold separates the exiting fluid into a relatively salt-free diluent product and a salt-enriched brine for disposal. The brine may be recirculated through the system if desired.

Referring now to FIG. 1A, the system 100 utilizes an anode 101, a cathode 102, and a voltage source 103. The electrical connectors 104 and 105 connect the anode 101 and cathode 102 to the voltage source 103. The electrical connector 104 connects the positive anode 101 to the voltage source 103 as indicated by the “+” sign. The electrical connector 105 connects the negative cathode 102 to the voltage source 103 as indicated by the “−” sign.

The system 100 utilizes a layered stack of membrane materials. Anion permeable membranes 106 and 106′ form a portion of the layered stack of membrane materials. Cation permeable membranes 107 and 107′ form a portion of the layered stack of membrane materials. The anion permeable membranes 106 and 106′ can be thought of as having a positive fixed charge. The anion membranes allow movement of anions through the membranes. Similarly, the cation permeable membranes 107 and 107′ have negative fixed charge.

The system 100 utilizes selective ion exchange resins for contaminant ions of interest to particularly benefit the treatment of low concentration or marginally impaired water. The water flowing through the system 100 is divided into a concentrate (or brine) water stream 108, 108′ and a diluent (or process) water stream 109, 109′. Ion specific ion exchange resins 110, 110′ are packed between the anion permeable membranes 106, 106′ and the cation permeable membranes 107, 107′ in the diluent (or process) water stream 109, 109′ but not in the concentrate (or brine) water stream 108, 108′. Various current or available methods of arrangement of membranes adjacent to the electrodes (104, 105) may be used to control water chemistry and process near the electrodes. These solutions flowing adjacent to the electrodes may be separated from the dilutent or concentrate streams.

The system 100 operates to perform functions such as nitrate removal, water purification, and selective ion transportation. For example, to provide selectivity for nitrate removal, the anion permeable membranes 106 106′ are nanoengineered to provide relatively rapid nitrate movement through the membrane nanopores. The cation permeable membranes 107, 107′ are used for the companion positive charged ions to remove the nitrate salt that could either by re-cycled for use or disposed of.

The charge on the membranes alternates from positive to negative through the membrane stack. An electrical potential gradient is placed across the entire membrane stack and used to drive ions though the membranes. The negative ions are drawn toward the anode 101 as illustrated by the arrows 111, 111′. The positive ions are drawn toward the cathode 102 as illustrated by the arrows 112, 112′. The fluid to be treated is pumped through the membranes as illustrated by the arrows 109, 109′ and the targeted species and its counter ion is concentrated in alternate cells. A manifold is attached to the distal end of the system 100 and used to collect the separate water streams.

The system 100 removes contaminants from water by providing a layered stack of anion permeable membranes and cation permeable membranes, an anode, a cathode, and a voltage source connected to the anode and the cathode. The layered stack of anion permeable membranes and cation permeable membranes are positioned between the anode and the cathode so that the layered stack of membranes forms a concentrate water stream flow channel between the alternating individual anion permeable membranes and individual cation permeable membranes and a diluent water stream flow channel between alternating individual anion permeable membranes and individual cation permeable membranes. Ion specific ion exchange resins are inserted within the diluent water stream flow channel. The water stream is pumped through the layered stack of anion permeable membranes and cation permeable membranes. The concentrate water stream flows through the concentrate water stream flow channel and wherein the diluent water stream flows through the diluent water stream flow channel and the ion specific ion exchange resins. By using the anode, the cathode, and the voltage source to place an electrical potential gradient across the layered stack of anion permeable membranes and cation permeable membranes to produce negative ions and positive ions in the diluent water stream wherein the negative ions are drawn toward the anode and the positive ions are drawn toward the cathode in the diluent water stream that flows through the diluent water stream flow channel.

Referring now to FIG. 1B, a portion of the system 100 illustrated in FIG. 1A is shown in greater detail. The system 100 utilizes the layered stack of membrane materials including anion permeable membrane 106 and cation permeable membrane 107. As described previously, the anion permeable membrane 106 has a positive fixed charge. The cation permeable membrane 107 has negative fixed charge.

The water flowing through the system 100 is divided into the concentrate (or brine) water stream 108 and a diluent (or process) water stream 109. A layer of ion specific ion exchange resins 110 is packed between the anion permeable membrane 106 and the cation permeable membrane 107 in the diluent (or process) water stream 109 but not in the concentrate (or brine) water stream 108.

The system 100 operates to perform functions such as nitrate removal, water purification, and selective ion transportation. For example, to provide selectivity for nitrate removal, the anion permeable membrane 106 can be nanoengineered to provide relatively rapid nitrate movement through the membrane nanopores. The cation permeable membrane 107 is used for the companion positive charged ions to remove the nitrate salt that could either by re-cycled for use or disposed of. Alternatively, the system could be designed to be particularly selective for cations(s) or combinations of anions and cations.

The charge on the membranes alternates from positive to negative through the membrane stack. An electrical potential gradient is placed across the entire membrane stack and used to drive ions though the membranes. The negative ions are drawn toward the anode as illustrated by the arrow 111. The positive ions are drawn toward the cathode 102 as illustrated by the arrow 112. The fluid to be treated is pumped through the membranes as illustrated by the arrow 109.

### SPECIFIC EXAMPLES

Nitrate contamination is becoming a problematic contaminant in various parts of the country due to run off from agricultural or livestock operations or due to fertilizer or septic tank systems. With revisions downward of the allowable concentration of nitrate in drinking water (˜44 ppm) increasing numbers of water sources including well water are exceeding the allowable levels. In some cases the amount of nitrate is slightly above the allowable level. Consequently, reliable and automated methods to remove small amounts of nitrate from drinking water would be very beneficial particularly if the treatment system can operate without requirements for chemical feedstocks or significant monitoring by water treatment professionals. While reverse osmosis and ion exchange can be used to remove ionic contaminants these have high energy costs and/or significant recurring operational tasks.

Arsenic contamination occasionally shows up in water supplies from natural sources. Due to the low allowable concentration (˜5 ppb) even small amounts in the water are problematic. Since only a small amount needs to be removed an ion-specific approach is highly desirable.

Perchlorate (ClO₄—) is an ionic contaminant that has entered groundwater sources (aquifers) in many communities. It is a main component in propellants and road flares among other uses. A public health goal on the order of 5 ppb or less is expected. Unfortunately, there are many groundwater sources that are contaminated with perchlorate including the Colorado River. A large volume of water in the US is contaminated with perchlorate including a large number of water wells which normally do not receive extensive treatment.

Other contaminant ions may be present in any given water source. To the extent that efficient ion specific extraction can be obtained by an ion selective resin, this invention could prove beneficial in treatment of those water sources through additions of other ion-specific resins.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An apparatus for removing contaminants from water wherein the water includes a concentrate water stream and a diluent water stream, comprising:
an anode;
a cathode;
a voltage source connected to said anode and to said cathode;
a layered stack of membranes between said anode and said cathode, said layered stack of membranes comprising
a multiplicity of anion permeable membranes positioned between said anode and said cathode, said multiplicity of anion permeable membranes including individual anion permeable membranes;
a multiplicity of cation permeable membranes positioned between said anode and said cathode, said multiplicity of cation permeable membranes including individual cation permeable membranes,
wherein said layered stack of membranes comprises alternating individual anion permeable membranes and individual cation permeable membranes;
a concentrate water stream flow channel between said alternating individual anion permeable membranes and individual cation permeable membranes,
a diluent water stream flow channel between alternating individual anion permeable membranes and individual cation permeable membranes; and
ion specific ion exchange resins within said diluent water stream flow channel.

2. The apparatus for removing contaminants from water of claim 1 wherein the concentrate water stream and the diluent water stream originate from a common original water stream and wherein the concentrate water stream flows through said concentrate water stream flow channel between said alternating individual anion permeable membranes and individual cation permeable membranes and wherein said diluent water stream flows through said flow channel between alternating individual anion permeable membranes and individual cation permeable membranes.

3. The apparatus for removing contaminants from water of claim 1 wherein the concentrate water stream and the diluent water stream originate from separate water streams and wherein the concentrate water stream flows through said concentrate water stream flow channel between said alternating individual anion permeable membranes and individual cation permeable membranes and wherein said diluent water stream flows through said flow channel between alternating individual anion permeable membranes and individual cation permeable membranes.

4. The apparatus for removing contaminants from water of claim 1 including a controller for turning said voltage source on and off.

6. The apparatus for removing contaminants from water of claim 1 including a controller for cycling said voltage source.

7. The apparatus for removing contaminants from water of claim 1 wherein said ion specific ion exchange resins within said diluent water stream flow channel are nitrate specific ion exchange resins.

8. The apparatus for removing contaminants from water of claim 1 wherein said ion specific ion exchange resins within said diluent water stream flow channel are perchlorate specific ion exchange resins.

9. The apparatus for removing contaminants from water of claim 1 wherein said ion specific ion exchange resins within said diluent water stream flow channel are arsenate specific ion exchange resins.

10. The apparatus for removing contaminants from water of claim 1 wherein said ion specific ion exchange resins within said diluent water stream flow channel are carbonate specific ion exchange resins.

11. The apparatus for removing contaminants from water of claim 1 wherein said ion specific ion exchange resins within said diluent water stream flow channel are chloride specific ion exchange resins.

12. The apparatus for removing contaminants from water of claim 1 wherein said multiplicity of anion permeable membranes are a multiplicity of nanoporous anion permeable membranes.

13. The apparatus for removing contaminants from water of claim 1 wherein said multiplicity of cation permeable membranes are a multiplicity of nanoporous cation permeable membranes.

14. The apparatus for removing contaminants from water of claim 1 wherein said multiplicity of anion permeable membranes are a multiplicity of nanoporous anion permeable membranes and wherein said multiplicity of cation permeable membranes are a multiplicity of nanoporous cation permeable membranes.

15. A method of removing contaminants from water wherein the water includes a concentrate water stream and a diluent water stream, comprising:
providing a layered stack of anion permeable membranes and cation permeable membranes, an anode, a cathode, and a voltage source connected to said anode and said cathode;
positioning said layered stack of anion permeable membranes and cation permeable membranes between said anode and said cathode so that said layered stack of membranes forms a concentrate water stream flow channel between said alternating individual anion permeable membranes and individual cation permeable membranes and a diluent water stream flow channel between alternating individual anion permeable membranes and individual cation permeable membranes;
inserting ion specific ion exchange resins within said diluent water stream flow channel;
pumping said water stream through said layered stack of anion permeable membranes and cation permeable membranes, wherein said concentrate water stream flows through said concentrate water stream flow channel and wherein said diluent water stream flows through said diluent water stream flow channel and said ion specific ion exchange resins;
using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel.

16. The method of removing contaminants from water of claim 15 including the step of turning said voltage source on and off.

17. The method of removing contaminants from water of claim 15 including the step of cycling said voltage source.

18. The method of removing contaminants from water of claim 15 including the step of recirculating said water stream through said layered stack of anion permeable membranes and cation permeable membranes by additionally pumping said water stream through said layered stack of anion permeable membranes and cation permeable membranes, wherein said concentrate water stream flows through said concentrate water stream flow channel and wherein said diluent water stream flows through said diluent water stream flow channel and said ion specific ion exchange resins.

19. A method of concentrating specific species of contaminants in water wherein the water includes a concentrate water stream and a diluent water stream, comprising:
providing a layered stack of anion permeable membranes and cation permeable membranes, an anode, a cathode, and a voltage source connected to said anode and said cathode;
positioning said layered stack of anion permeable membranes and cation permeable membranes between said anode and said cathode so that said layered stack of membranes forms a concentrate water stream flow channel between said alternating individual anion permeable membranes and individual cation permeable membranes and a diluent water stream flow channel between alternating individual anion permeable membranes and individual cation permeable membranes;
inserting ion specific ion exchange resins within said diluent water stream flow channel;
pumping said water stream through said layered stack of anion permeable membranes and cation permeable membranes, wherein said concentrate water stream flows through said concentrate water stream flow channel and wherein said diluent water stream flows through said diluent water stream flow channel and said ion specific ion exchange resins;
using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate the specific species of contaminants in said diluent water stream.

20. The method of concentrating specific species of contaminants in water wherein the specific species is perchlorate and wherein said step of using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate the specific species of contaminants in said diluent water stream comprises:
using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate perchlorate in said diluent water stream.

21. The method of concentrating specific species of contaminants in water wherein the specific species is nitrate and wherein said step of using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate the specific species of contaminants in said diluent water stream comprises:
using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate nitrate in said diluent water stream.

22. The method of concentrating specific species of contaminants in water wherein the specific species is arsenic and wherein said step of using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate the specific species of contaminants in said diluent water stream comprises:
using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate arsenic in said diluent water stream.

23. The method of concentrating specific species of contaminants in water wherein the specific species is chloride and wherein said step of using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate the specific species of contaminants in said diluent water stream comprises:
using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate chloride in said diluent water stream.

24. The method of concentrating specific species of contaminants in water wherein the specific species is carbonate and wherein said step of using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate the specific species of contaminants in said diluent water stream comprises:
using said anode, said cathode, and said voltage source to place an electrical potential gradient across said layered stack of anion permeable membranes and cation permeable membranes to produce negative ions and positive ions in said diluent water stream wherein said negative ions are drawn toward said anode and said positive ions are drawn toward said cathode in said diluent water stream that flows through said diluent water stream flow channel to concentrate carbonate in said diluent water stream.
